(19) United States
(12) Patent Application Publication
(10) Pub. No.: US 2005/0092735 A1
(43) Pub. Date: May 5, 2005

(54) Heating device comprising a flexible heating element

(75) Inventors: Ernst Merk, Weissenhorn (DE); Ralf Kohler, Langenau (DE)

Correspondence Address: PAULEY PETERSEN & ERICKSON, 2800 WEST HIGGINS ROAD, SUITE 365, HOFFMAN ESTATES, IL, 60195, US

(73) Assignee: Beurer GmbH & Co, Ulm (DE)

(21) Appl. No.: 10/500,731

(22) PCT Filed: Jan. 10, 2003
(86) PCT No.: PCT/EP03/00178

(30) Foreign Application Priority Data
Jan. 12, 2002 (DE) 102 00 974.0

(51) Int. Cl. H05B 1/02

(52) U.S. Cl. 219/494

(57) ABSTRACT

A heating device including an electric heat conductor arrangement which is integrated in a flexible heating element and can be connected to a supply voltage via a connection cable. The heating device also includes a heating circuit, which is formed with the heat conductor arrangement and with other elements including a control element for a heating current, and includes a trigger circuit, which has a control loop and is connected to the control element in order to vary the heating current and regulate the temperature, whereby the control element is triggered based on a deviation between an actual value and a set value. A simple design with reliable temperature regulation is obtained because the trigger circuit is also coupled to the heating circuit via a coupling branch in order to tap an electric measured variable current or voltage that varies according to the temperature of the heat conductor arrangement. Also, the trigger circuit includes a control loop with a digitizing stage of a digital circuit arrangement. The trigger circuit is configured so that the triggering of the control element for adjusting a set temperature of the heating element occurs based on digital data generated in the digitizing stage.

### BACKGROUND OF THE INVENTION

1. Field of the Invention

This invention relates to a heating device having an electrical heating conductor arrangement, which is integrated into a flexible heating element and can be connected to a supply voltage via a connector cable, a heating circuit formed by the heating conductor arrangement and other elements, including a control member for a heating current, and a triggering circuit with a control loop connected to the control member for varying the heating current and regulating the temperature, wherein the control member is controlled as a function of a deviation between an actual value and a rated value.

2. Discussion of Related Art

A heating device is disclosed in European Patent Reference EP 0 562 850 A2, which relates to a circuit for the protection against overheating of the electrical heating conductor arrangement integrated into the flexible heating element. The triggering circuit also has a temperature control loop, by which a heating current is varied by a control member in the form of a thyristor for maintaining a desired temperature. Other embodiments of the control member are also mentioned, for example a mechanical, thermal or other electronic switch. However, no detailed information regarding the structure of a control loop is provided.

### SUMMARY OF THE INVENTION

This invention makes available a heating device of the type mentioned above but which offers advantages in view of the design of the control loop.

This object is achieved with characteristics of this invention as discussed in this specification and in the claims. In accordance with this invention, a triggering circuit is coupled via a coupling branch to a heating circuit for picking up an electrical measurement value, such as current or voltage, which is a function of the temperature of the heating conductor arrangement, and has a control loop with a digitizing stage of a digital circuit arrangement. The triggering circuit is such that the control of the control member for regulating a set temperature of the heating element occurs on the basis of data developed by the digitizing stage.

This embodiment of the triggering circuit with a control loop having a digitizing stage and by which the regulation of the set temperature occurs on the basis of developed digital data allows an accurate and dependable temperature regulation, which can also be designed without difficulties to meet different requirements, for example regarding the type and speed of the regulation of the temperature, or as a function of the type of the flexible element, for example a blanket or a pad or a heated mattress pad. The digital circuit arrangement is preferably a micro-controller, but can also be, for example, a specially constructed digital circuit arrangement, such as an ASIC, a CMOS gate, or the like.

For developing the actual value, the measured quantity is picked up by a voltage divider formed in the heating circuit, which is formed by the heating conductor arrangement constituting a temperature-dependent resistor, and also by at least one resistor element. The heating conductor arrangement, which is provided, is used as a temperature sensor.

Different structural variations exist because the measured quantity is conducted indirectly or directly to the digitizing stage via a feed branch for developing a digital actual value. Thus a wireless path for transmitting the measured quantity is also possible.

An advantageous structure of the triggering circuit, in particular the control loop, results because the measured quantity is supplied to an analog time function element arranged upstream of the digitizing stage and has a resistor/capacitor circuit. The digitizing stage has a time-measuring element for developing the actual digital value, and the actual digital value corresponds to an actual time value until a preset or presettable charge voltage of the capacitor is reached. In the digitizing stage a rated time value can be preset or is presettable as the rated value, and for heating, the triggering of the control member occurs as a function of the deviation of an actual time value from the rated time value.

One connector of the capacitor is coupled via a charging resistor to a pole of the supply voltage, and the other connector is coupled to the heating circuit via the coupling branch. For detecting the measured quantity and developing the actual value the control member is triggered by the digital circuit arrangement.

If the capacitor is connected to the supply voltage by a rectifier, it is possible, for example with a line supply voltage, to advantageously utilize half-waves for triggering and developing the actual values and/or rated values.

In one embodiment of the structure and the performance of the regulation, for developing the rated value the control member is brought into its non-triggered state in which it interrupts the heating circuit, and the other connector of the capacitor is connected to a further voltage divider for picking up a component voltage which can be set to correspond to a desired temperature, and for developing the rated value from the component voltage.

Thus, individual periods of time of the control can be unequivocally subdivided because the pick-up of the component voltage takes place by a switching member which is temporarily triggered via the digital circuit arrangement. The developed rated value and/or the developed actual value is/are stored for performing a rated/actual value comparison in the digital circuit arrangement.

The dependability and accuracy of the temperature regulation is aided because the digital circuit arrangement is designed for generating a reference value as the common reference value for the rated value and the actual value. With this step it is possible, for example by appropriate programs in the digital circuit arrangement, in particular a micro-controller or a micro-computer, to also detect the type and/or location of errors, or to include suitable correction values.

Thus an advantageous embodiment of a simple, dependably functioning construction exists because for developing the reference value the control member and the switching member are placed in their interrupted state and the capacitor, which is connected via the one or the other connector with the digital circuit arrangement, can be discharged by the latter for performing the reference measurement, and is subsequently charged via the charging branch, the coupling branch and the resistor element of the heating circuit. In the process the time until the charge voltage of the capacitor is reached, measured by the time-measuring member of the digital circuit arrangement, is stored as a reference value. In this case, the time function element of the resistor/capacitor circuit is used not only for developing the actual value and the rated value, but also for developing the reference value, resulting in increased dependability.

A structure which is advantageous for performing the temperature regulation includes the digital circuit arrangement embodied so that, for temperature regulation, initially the reference value during a supply half-wave is determined, and then the rated value and the actual value are determined during respective further half-waves. The temperature is adjusted on the basis of a comparison of the rated value and the actual value and, following an intermission in which the triggering of the control member is interrupted, the mentioned steps from the reference value development to the intermission time are cyclically repeated.

### BRIEF DESCRIPTION OF THE DRAWINGS

This invention is described in greater detail in view of exemplary embodiments represented in the drawings, wherein:

FIG. 1 is a schematic view of an electrical circuit of a heating device; and

FIG. 2 shows a graphical representation of voltage curves of a time function element, applied over time, for deriving an actual value, a rated value and a reference value.

### DESCRIPTION OF PREFERRED EMBODIMENTS

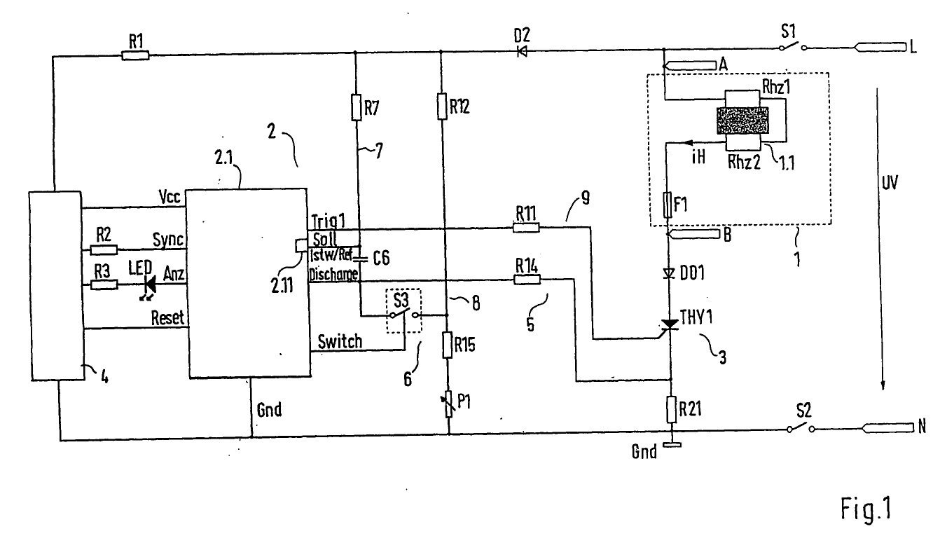

A heating device with a flexible heating element 1 is shown in FIG. 1, for example in the form of a heating blanket, a heating pad or a heated mattress pad, into which a heating conductor arrangement is integrated and a safety fuse F1 is housed, and having a triggering circuit 2 acting on a heating circuit 3, by which a heating current iH flowing through the heating circuit 3 with the heating conductor arrangement 1.1 can be varied for setting a desired temperature. The heating circuit 3, which is connected to a supply voltage UV, for example a line voltage, an otherwise transformed voltage or a d.c. voltage, and which can be cut off from it by switches S1, S2, has, following the heating conductor arrangement 1.1 and the safety fuse F1, a diode, which is connected in the conducting direction of a positive half-wave, a control member THY1 in the form of a thyristor or triac, or other semiconductor switch, or electronically operable mechanical contact, and a voltage divider resistor R21, which is connected to ground with its connector remote from the control member THY1 and forms, together with the heating conductor arrangement 1.1, a voltage divider. The heating conductors Rhz1, Rhz2 of the heating conductor arrangement 1.1 are insulated from each other, preferably by an insulator which melts at a suitable temperature, and are connected with each other as the inner conductor and the outer conductor of a heating cord, as is known per se, by which a compensation of the electromagnetic field is also achieved. The heating conductor arrangement 1.1 is connected at, for example two, connecting points A, B in the edge area of the flexible heating element 1, or to a short piece of cable with a plug/connector unit, and is releasable from the heating circuit 3, or is connected with the heating circuit 3 by a fixed connector cable. The safety fuse F1 can also be arranged outside of the flexible heating element 1 in the heating circuit 3, for example in the plug/connector unit. The heating resistors Rhz1, Rhz2 have a temperature-dependent resistance, for example with a positive temperature coefficient (PTC effect) or a negative temperature coefficient (NTC effect), so that the voltage divider formed together with the voltage divider resistor R21 is temperature-dependent. Several heating circuits 3 can be provided in parallel or in series, wherein several heating cords are correspondingly arranged in the heating element 1.

The triggering circuit 2 is connected via a coupling branch 5 for picking up the component voltage developed by the voltage divider from the voltage divider resistor R21 and the heating conductor arrangement 1.1, as well as via a triggering branch 9 to a control input of the control member THY1, and has a digital circuit arrangement 2.1, which is powered via an energy supply device 4 and is designed, for example, as a micro-computer, micro-controller, special integrated circuit arrangement (ASIC), CMOS gate or the like, also a time function element, integrated into charging branch 7 and a rated value branch 6 including a resistor/capacitor circuit R7, C6 and a further voltage divider 8 connected to the supply voltage UV and having fixed resistors R12, R15 and an adjustable resistor P1, wherein a further diode D2 is inserted in the conduction direction into the positive potential connection to the supply voltage UV. In this case the further diode D2 is arranged so that the entire triggering circuit 2 is connected by the latter to the supply voltage UV.

An adjustable component voltage, which can be selected in accordance with a desired temperature of the heating element 1, is picked up at the further voltage divider 8 between the fixed resistors R12, R15 forming the rated value branch 6 and can be set by the adjustable resistor in the form of the potentiometer P1. The potentiometer P1 is located between the fixed resistor R15 on the ground side and the ground Gnd. The component voltage picked up at the further voltage divider 8 is applied to the capacitor C6 via a controllable switch S3, which for opening and closing is connected to the digital circuit arrangement 2.1 via a connecting switch. Thus, the capacitor C6 is connected with one connector to a positive pole of the supply voltage UV via the charging resistor R7 for charging, and with another connector to ground via the controllable switch S3 and the fixed resistor R15 and the potentiometer P1 forming the rated value branch 6 wherein, for developing a rated value, the rated value branch 6 can be temporarily closed by the controllable switch S3 in accordance with a triggering algorithm fixed in the digital circuit arrangement 2.1. The connector of the capacitor C6 connected with the charging resistor R7 is also connected with an input connector of the digital circuit arrangement 2.1 for detecting the charge voltage and conducting it to a digitizing stage 2.11, while the other connector of the capacitor C6 is preferably connected to a discharge connection (Discharge) of the digital circuit arrangement 2.1 in order to perform a complete controlled discharge of the capacitor C6. This other connector of the capacitor C2 is also connected via the coupling branch 5 with a resistor R14 for picking up the component voltage at the resistor R21 of the heating circuit 3, i.e. an actual measured quantity as a function of the temperature of the heating conductor arrangement 1.1, and thus of the heating element 1, wherein the connecting point lies in the heating circuit 3 between the control member THY1 and the voltage divider resistor R21. The triggering branch 9 contains a resistor R11 and is connected to a control connector Trig1 of the digital control circuit 2.1 in order to perform a temperature regulation of the heating element 1 as a function of a rated value/actual value comparison, wherein suitable regulating algorithms can be preset or programmed by the digital circuit arrangement 2.1.

Alternatively the discharge connection Discharge can also be omitted. Instead of generating component voltages via the resistors R7 and R12, it is also possible to apply corresponding d.c. voltages, which are separated from the load circuit (heater), so that the resistors R7 and R12 can be omitted. Furthermore, various rated values can be preset in the digital circuit arrangement and picked up via assigned connections, which can be suitably contacted by a change-over switch. The resistors R12, R15, P1 and the switch S3 can thus be replaced. In that case, pre-setting of the rated value does not take place via the changed resistor P1, but rather by the change-over switch. For example, it is possible to provide a temperature-stabilized time cycle or a reference time in the digital circuit arrangement 2.1 for this purpose.

On the other side, the digital circuit arrangement 2.1 is connected via a connector Vcc to the energy supply device 4, and by a ground connector Gnd to ground potential. Also, further connections of the digital circuit arrangement 2.1 with the energy supply device 4 exist via a synchronizing connection Sync, a display connection Anz, and a reset connection Reset, wherein a resistor R2 is connected to the synchronizing connection Sync, and a display, for example in the form of a light-emitting diode LED, and a resistor arrangement R3, are connected to the display connection Anz. The energy supply device 4 is connected on one side to ground, and on the other side to the supply voltage UV via a resistor R1 and the further diode D2.

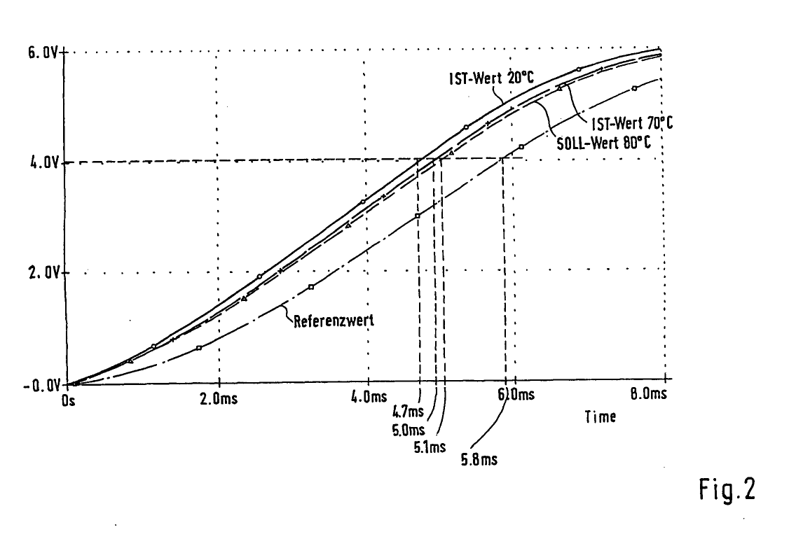

The procedure in connection with the temperature regulation will be described in view of the heating device shown in FIG. 1 and of charge curves of the capacitor C6 represented in FIG. 2, from which the actual value at various temperatures of the heating conductor arrangement 1.1 and the rated value are derived. The reference value, the rated value and the actual value are respectively determined from the charge curves of the variously wired capacitor C6, which is controlled by the digital circuit arrangement 2.1, wherein the charge times of the capacitor C6 to a defined charge voltage are determined by a digitizing stage 2.11 provided in the digital circuit arrangement 2.1. A digital time-measuring member with a fixed time cycle and a counter is provided in the digital circuit arrangement 2.1. With a comparison of the actual value in the form of an actual time value with a rated value in the form of a rated time value a decision regarding the supply of the heating current iH is made by the control member THY1, for example regarding heating or not heating.

Large supply voltage ranges of approximately 100 V to 250 V, and frequency ranges of customary line supply voltages of approximately 50 to 60 Hz are simply covered by the present steps for developing the actual value and the rated value, wherein the customary resolution of the digitizing stage 2.11, or of the digital time-measuring member is sufficient, but can also be slightly enlarged, if desired. The increase in resolution can take place simply by increasing the cycle frequency, for example automatically, with a corresponding switching of the supply voltage. For example, this can take place as a function of the dynamic reference value in the memory of the digital circuit arrangement 2.1, which is set according to the supply voltage.

For determining the reference value, the capacitor C6 is completely discharged via the connectors Ist/Ref and Discharge, for example during a negative half-wave of the supply voltage UV, which is the line voltage, for example. The controllable switch S3 and the power circuit breaker in the form of the control member THY1 are not triggered, for example are open during the reference measurement. A zero voltage passage of each positive half-wave is detected by the synchronizing connection Sync, and following voltage zero the charging process of the capacitor C6 takes place as a function of the resistors R7, R14, R21 and the further diode D2 until a digital switching level is reached at the reference input of the digital circuit arrangement 2.1. At a line frequency of 50 Hz, the charge time, which forms the reference value, is for example 5.8 ms as shown in FIG. 2.

The controlled switch S3 is not triggered for developing the actual value, for example it remains open, while the control member THY1 is triggered, for example the heating circuit 3 is closed. Because of the current flow over the heating resistors Rhz1 and Rhz2 which are formed by the heating conductors, over the safety fuse F1, the diode D01, the control member THY1 and the voltage divider resistor R21, a voltage drop U21, which is proportional to the temperature, is created at the voltage divider resistor R21. For example, the component voltage in the form of the voltage drop U21 is approximately 1 V at a heating conductor temperature of 20° C. (peak of the positive sinus half-wave), and at the maximum temperature (80° C.) approximately 0.7 V. Because of the parallel increase of the positive charging voltage at the charging resistor R7 and the rise by the component voltage U21, the charging process of the capacitor C6 until the switching level is reached is reduced to a charging time, or an actual time value, of approximately 4.7 ms at 20° C. If, because of the heating of the heating conductor arrangement 1.1 to 70° C. as a result of the PTC effect, the component voltage U21 is reduced to approximately 0.75 V in the maximum of the sinus half-wave, the charging process of the capacitor C6 takes place in approximately 5.0 ms.

For developing the rated value in the form of the rated time value, the charging voltage of the capacitor C6, with the control member not triggered, for example with an open heating circuit 3, and switched-on, for example closed controllable switch S3, is raised by the potentiometer P1 by approximately 0.7 V (maximum of the positive sinus half-wave) at the maximum temperature setting (80° C). This corresponds to the component voltage U21 at the maximum temperature and results in a charging time of the capacitor C6 until the switching level is reached of 5.1 ms (rated time value at 80° C.). Thus, the rated value branch 6 results because of the structural components of the further diode D2, resistor R7, capacitor C6, controllable switch S3, resistor R15 and adjustable resistor P1, together with the resistor R12 of the further voltage divider 8, wherein the controllable switch S3 is triggered by the digital circuit arrangement 2.1 via the connection Switch.

During the temperature regulation, first the reference value is determined, then the rated value and the actual value are determined as rated time value and actual time value. With the comparison of the charging times at the capacitor C6 performed on the basis of the derived digital data of the actual time values and the rated time value a heating or not heating decision is then made. When reaching the maximum temperature, identical charging times result at the capacitor C6 (wherein the component voltage U21 is 0.7 V), such as in the present case 5.1 ms. The triggering of the control member THY1 is then interrupted, and a pause of approximately 1 s is inserted. Then the reference, rated and actual values are respectively determined with three line half-waves. With a further comparison a decision regarding heating or not heating is again made. In case of non-heating a pause of 1 s is again inserted. This sequence is repeated.

In particular, the comparison of the rated value and the actual value in the digital circuit arrangement 2.1 can also be provided to other regulating algorithms in order to provide the heating current iH in the heating circuit 3 via the control member THY1 as a function of a desired chronological temperature behavior, and/or as a function of the type of the flexible heating element 1, for example a heating blanket, a heating pad or a heated mattress pad. A suitable control algorithm can be easily programmed by a micro-computer or micro-controller, wherein it is possible to satisfy safety regulations.

In one embodiment of temperature regulation, a rated value is increased and a controlled rated value is decreased to a rated value. Because of the thermal delay of the rise of the surface temperature of the heating element to the heating conductor temperature because of poor heat conduction of the materials of the flexible heating element 1 it is desirable, for example, to improve the temperature rise. A rated temperature value can be determined as a function of time after the heating device is switched on. For achieving an excess surface temperature of an already pre-warmed heating element, the rated value for the regulation is predetermined by an optimized method. By determining the difference between the rated value and the actual value this can lead to a calculated temporary reheating as a result thereof after the rated temperature value is reached. Alternatively, it is possible to fix a calculated higher rated value for the regulation, for example from a comparison of the rated temperature and the actual temperature. Thus, if the rated value/actual value difference at the switch-on time is large, a large rated value increase is fixed. The increase is then maintained constant or is varied, for example, until the actual value agrees with the increased rated value. Then a temperature gradation derived from the rated value increase is started. Thus there is one advantage that the surface temperature does not break down. But if in contrast to this the rated value/actual value difference is the same at switch-on as during the operation, no rated value increase and no controlled rated value reduction to the rated value are performed. Appropriate parameters for gauging the rated value/actual value difference can be stored in the digital circuit arrangement 2.1. Depending on the type of the flexible heating element 1, for example heating pad, heated mattress pad or heating blankets, it is also possible to provide a different calculating method for the rated value increase. For example, this can be realized by the evaluation of stored software or by programmed digital inputs, or also by a time-controlled connection with or switching to another rated value stage.

The described reference measurement can be employed for the detection of errors. Thus, the measured reference value of the charging time can be compared with the rated value and/or the actual value, and with the results of the comparison and on the basis of already known, or stored, or input values it is possible to detect an error in the electronic device, for example a short circuit in the control member THY1, or in connection with the controllable switch S3. The errors can be exactly localized and displayed by plausibility comparisons. The display can be designed as a simple luminous indicator up to a variable display indicator, wherein triggering by the digital circuit arrangement 2.1 can be designed in different ways, for example as a blinking warning display, or also acoustically.

Switching off the heating device can take place by a single or multiple time switch, wherein switch-off times can be fixedly integrated, or separately switchable. During extended operations a temperature reduction can be provided by an appropriate programming of the digital circuit arrangement 2.1 in order to prevent burning of the skin because of continuously high surface temperatures of the heating element. Thus it is possible to provide, starting at a defined rate temperature value, a time-dependent step-down of the rated value, or even the switching off of the heater.

With the display device, defined as a display unit LED, for example, the various operating states of the heating devices, for example reduction of the rated value, timed shut-off, or the like, can be indicated to the user in a multitude of ways, for example by color, numbers, symbols, texts or the like. It is thus possible to achieve a blinking operation, changing colors, flash indicator or the like, as well as an indication by sound, voice or vibration. For example, a vibrating alarm can be provided in the heating element or in a switch on the cord until the lowering of the rated temperature value, in order to prevent, for example by a repeated operation, the user from falling asleep during critical phases.

1. A heating device comprising: an electrical heating conductor arrangement (1.1) integrated into a flexible heating element (1) and connectible to a supply voltage (UV) via a connector cable, a heating circuit (3) formed by the heating conductor arrangement a control member (THY1) for a heating current (iH), and a triggering circuit (2) with a control loop connected to the control circuit (3) for varying the heating current (iH) and regulating a temperature, wherein a control of the control member occurs as a function of a deviation between an actual value and a rated value, wherein the triggering circuit (2) is coupled via a coupling branch (5) to the heating circuit (3) for picking up an electrical measured value (U21) which is a function of the temperature of the heating conductor arrangement (2.1), and the control loop having a digitizing stage (2.11) of a digital circuit arrangement (2.1), and the triggering circuit (2) formed so that the control of the control member (THY1) for regulating a set temperature of the heating element (1) takes place on a basis of data developed by the digitizing stage (2.11); and
the measured value (U21) conducted indirectly to the digitizing stage (2.11) via a feed branch (5) for developing a digital actual value via an analog time function element arranged upstream of the digitizing stage (2.11) which has a resistor/capacitor circuit (R7, C6).

2. The heating device in accordance with claim 1, wherein the measured value (U21) is picked up by a voltage divider formed in the heating circuit (3), which is formed by the heating conductor arrangement (1.1) forming a temperature-dependent resistor, and by at least one resistor element (R21).

3. The heating device in accordance with claim 2, wherein the digitizing stage (2.11) has a time-measuring element for developing the actual digital value, and the actual digital value corresponds to an actual time value until one of a preset and a presettable charge voltage of a capacitor (C6) is reached, in the digitizing stage (2.11) a rated time value is one of preset and presettable as the rated value, and for heating the triggering of the control member (THY1) takes place as a function of the deviation of the actual time value from the rated time value.

4. The heating device in accordance with with claim 3, wherein one connector of the capacitor (C6) is coupled via a charging resistor (R7) to a pole of the supply voltage (UV) and an other connector is coupled to the heating circuit (3) via the coupling branch (5), and for detecting the measured value (U21) and developing the actual value the control member (THY1) is triggered by the digital circuit arrangement (2.1).

5. The heating device in accordance with claim 4, wherein the capacitor (C6) is connected to the supply voltage (UV) by a rectifier (D2).

6. The heating device in accordance with claim 5, wherein for developing the rated value the control member (THY1) is brought into a non-triggered state in which the control member (THY1) interrupts the heating circuit, and the other connector of the capacitor (C6) is connected to a voltage divider (8) for picking up a component voltage which is settable to a desired temperature and for developing the rated value from the component voltage.

7. The heating device in accordance with claim 6, wherein a detection of the component voltage takes place by a switching member (S3) which is temporarily triggered via the digital circuit arrangement (2.1), and at least one of a developed rated value and a developed actual value is stored for performing a rated/actual value comparison in the digital circuit arrangement (2.1).

8. The heating device in accordance with claim 7, wherein the digital circuit arrangement (2.1) generates a reference value as a common reference value for the rated value and the actual value.

9. The heating device in accordance with claim 8, wherein for developing the reference value the control member (THY1) and the switching member (S3) are placed in an interrupted state and the capacitor (C6) which is connected via one of the one connector and the other connector with the digital circuit arrangement (2.1), is dischargeable by the digital circuit arrangement (2.1) for performing the reference measurement, and is subsequently charged via the charging branch (7), the coupling branch (5) and the resistor element (R21) of the heating circuit (3), and the time until a charge voltage of the capacitor (C6) is reached, measured by the time-measuring member of the digital circuit arrangement (2.1), is stored as the reference value.

10. The heating device in accordance with claim 9, wherein the digital circuit arrangement (2.1), for temperature regulation, initially determines the reference value during a supply half-wave and then the rated value and the actual value are determined during respective further half-waves, and the temperature is adjusted on the basis of a comparison of the rated value and the actual value and following an intermission in which the triggering of the control member (THY1) is interrupted steps from the reference value development to the intermission time are cyclically repeated.

11. The heating device in accordance with claim 1, wherein the digitizing stage (2.11) has a time-measuring element for developing the actual digital value, and the actual digital value corresponds to an actual time value until one of a preset and a presettable charge voltage of a capacitor (C6) is reached, in the digitizing stage (2.11) a rated time value is one of preset and presettable as the rated value, and for heating the triggering of the control member (THY1) takes place as a function of the deviation of the actual time value from the rated time value.

12. The heating device in accordance with with claim 1, wherein one connector of a capacitor (C6) is coupled via a charging resistor (R7) to a pole of the supply voltage (UV) and an other connector is coupled to the heating circuit (3) via the coupling branch (5), and for detecting the measured value (U21) and developing the actual value the control member (THY1) is triggered by the digital circuit arrangement (2.1).

13. The heating device in accordance with claim 1, wherein a capacitor (C6) is connected to the supply voltage (UV) by a rectifier (D2).

14. The heating device in accordance with claim 1, wherein for developing the rated value the control member (THY1) is brought into a non-triggered state in which the control member (THY1) interrupts the heating circuit, and the other connector of a capacitor (C6) is connected to a voltage divider (8) for picking up a component voltage which is settable to a desired temperature and for developing the rated value from the component voltage.

15. The heating device in accordance with claim 14, wherein a detection of the component voltage takes place by a switching member (S3) which is temporarily triggered via the digital circuit arrangement (2.1), and at least one of a developed rated value and a developed actual value is stored for performing a rated/actual value comparison in the digital circuit arrangement (2.1).

16. The heating device in accordance with claim 1, wherein the digital circuit arrangement (2.1) generates a reference value as a common reference value for the rated value and the actual value.

17. The heating device in accordance with claim 16, wherein for developing the reference value the control member (THY1) and the switching member (S3) are placed in an interrupted state and the capacitor (C6) which is connected via one of the one connector and the other connector with the digital circuit arrangement (2.1), is dischargeable by the digital circuit arrangement (2.1) for performing the reference measurement, and is subsequently charged via the charging branch (7), the coupling branch (5) and the resistor element (R21) of the heating circuit (3), and the time until a charge voltage of a capacitor (C6) is reached, measured by the time-measuring member of the digital circuit arrangement (2.1), is stored as the reference value.

18. The heating device in accordance with claim 17, wherein the digital circuit arrangement (2.1), for temperature regulation, initially determines the reference value during a supply half-wave and then the rated value and the actual value are determined during respective further half-waves, and the temperature is adjusted on the basis of a comparison of the rated value and the actual value and following an intermission in which the triggering of the control member (THY1) is interrupted steps from the reference value development to the intermission time are cyclically repeated.
